(19) United States
(12) Patent Application Publication
(10) Pub. No.: US 2024/0219278 A1
(43) Pub. Date: Jul. 4, 2024

(54) STRUT ASSEMBLY FOR HIGH FREQUENCY ELASTOMER TESTING IN A TEST MACHINE USED FOR DAMPER TESTING

(71) Applicant: ILLINOIS TOOL WORKS INC., Glenview, IL (US)

(72) Inventors: Byron John Saari, Minneapolis, MN (US); Spencer Matthias Neitz, St. Paul, MN (US)

(21) Appl. No.: 18/543,566

(22) Filed: Dec. 18, 2023

Related U.S. Application Data
(60) Provisional application No. 63/435,224, filed on Dec. 23, 2022.

(51) Int. Cl. G01N 3/32; G01N 3/06

(52) U.S. Cl. CPC G01N 3/32; G01N 3/06

(57) ABSTRACT

A specimen support assembly for testing an elastomeric test specimen comprises first and second specimen supports. A force transducer and accelerometer assembly is connected to a second end of the first specimen support opposite the elastomeric test specimen and includes a force transducer and a first accelerometer operably coupled in series with the force transducer, the first accelerometer configured to measure acceleration of a first end of the test specimen when mounted in the first specimen support and provide a first acceleration output signal. An elongated strut has a first end connected to the force transducer and accelerometer assembly on an end opposite the first specimen support and has a second end opposite the first end. A second accelerometer is configured to measure acceleration of a second end of the test specimen when mounted in the second specimen support and provide a second acceleration output signal.

### BACKGROUND

The discussion below is merely provided for general back-ground information and is not intended to be used as an aid in determining the scope of the claimed subject matter.

Aspects of the present invention relate to testing machines used to test dampers such as those used in vehicle suspensions.

A testing machine commonly used for testing dampers includes a base having a pair of vertical columns supporting a crosshead above the base. An actuator is located in the base while a load cell is mounted to the crosshead. A damper to be tested is secured to specimen supports at either end with one specimen support coupled to the actuator and another coupled to the load cell. A displacement measuring sensor such as a linear encoder measures displacement of the test specimen during testing. Typical damper testing measures the damping constant and/or force vs. velocity and/or force vs displacement of a test damper specimen using an oscillating actuator. These damping characteristics excitation test frequencies are typically limited to a test frequency of <50 Hz. Dampers are generally in the range of about 0.4 to about 1.2 meters long, which is commonly accommodated in the testing machine by adjusting the position of the crosshead relative to the base using lifting devices that support the crosshead over the base.

In addition to damper testing, another common test machine is configured to test elastomeric specimens such as but not limited to motor mounts for internal combustion vehicles as well as electric vehicles. Other elastomeric components of the vehicle that can be tested include elastomeric components found in dampers. Elastomer testing is quite different than damper testing. Elastomer testing is performed at higher frequencies for instance greater than 400 Hz. For example, internal combustion motor mounts may require oscillating displacements and forces above or below 1000 Hz, while electric vehicle motor mounts may require oscillating displacements and forces above or below 3000 Hz. In the future, elastomer testing may require oscillating displacements and forces above or below 5000 Hz.

The most common measurement in elastomer testing is the dynamic stiffness amplitude and phase. Other similar dynamic characteristics (or properties) can be derived from these two dynamic characteristics. These characteristics are most often measured with a sine sweep or discrete stepped sine displacement input and the measured force response as a result of this sinusoidal displacement input. From the force and displacement measurement, the dynamic stiffness amplitude (also referred to as K* or K-star or K*(jw)) and the phase (or phase angle or loss angle or phase(jw)) are computed from

$$\vec{K} ( jw ) = \frac{\vec{F} ( jw )}{\vec{X} ( jw )}$$

Where [symbol] (jw) and [symbol] (jw) are the measured complex force vector and displacement vector respectively.

$${K}^{*} ( jw ) = \vert \vec{K} ( jw ) \vert = \frac{\vert \vec{F} ( jw ) \vert}{\vert \vec{X} ( jw ) \vert}$$

$$phase ( jw ) = ∢ \vec{K} ( jw ) = ∢ \vec{F} ( jw ) - ∢ \vec{X} ( jw ) .$$

The testing machine used for elastomer testing has the same basic elements as the testing machine used for dampers that being a base supporting a pair of vertical columns which in turn support a crosshead over the base, in view that the elastomer test specimens are considerably smaller than a damper such as about 0.1 to about 0.3 meters in length (or height when mounted in the elastomer testing machine), the separation between the crosshead and the base is considerably less than that of the testing machine used for dampers. It should also be noted that the crosshead in a damper testing machine cannot be lowered to a position similar to that found in elastomer testing machines due to the physical attributes of the lifting devices used to move the crosshead relative to the columns and/or, when the crosshead is fixed stationary to the columns, the overall length of the columns. Hence, currently, it is necessary for damper testing to be performed on a testing machine specifically designed for testing dampers, while elastomer testing is likewise performed on testing machines specifically designed for testing elastomers.

### SUMMARY

This Summary and the Abstract herein are provided to introduce a selection of concepts in a simplified form that are further described below in the Detailed Description. This Summary and the Abstract are not intended to identify key features or essential features of the claimed subject matter, nor are they intended to be used as an aid in determining the scope of the claimed subject matter. The claimed subject matter is not limited to implementations that solve any or all disadvantages noted in the Background.

Without limitation some aspects of the invention include a specimen support assembly for testing an elastomeric test specimen in a testing machine. The assembly comprises a first specimen support having a first end configured to engage a first end of the elastomeric test specimen, and a second specimen support having a first end configured to engage a second end of the elastomeric test specimen. A force transducer and accelerometer assembly is connected to a second end of the first specimen support opposite the elastomeric test specimen and includes a force transducer and a first accelerometer operably coupled in series with the force transducer, the first accelerometer configured to measure acceleration of a first end of the test specimen when mounted in the first specimen support and provide a first acceleration output signal. An elongated strut has a first end connected to the force transducer and accelerometer assembly on an end opposite the first specimen support and has a second end opposite the first end. A second accelerometer is configured to measure acceleration of a second end of the test specimen when mounted in the second specimen support and provide a second acceleration output signal.

A second aspect of the invention is a testing system for applying loads to an elastomeric test specimen. The testing system comprises a base, a crosshead and a pair of vertical columns mounted to the base and the crosshead to support the crosshead above the base. A specimen holding assembly comprises a first specimen support having a first end configured to engage a first end of the elastomeric test specimen, and a second specimen support having a first end configured to engage a second end of the elastomeric test specimen. A force transducer and accelerometer assembly is connected to a second end of the first specimen support opposite the elastomeric test specimen and includes a force transducer and a first accelerometer operably coupled in series with the force transducer, the first accelerometer configured to measure acceleration of a first end of the test specimen when mounted in the first specimen support and provide a first acceleration output signal. An elongated strut has a first end connected to the force transducer and accelerometer assembly on an end opposite the first specimen support and has a second end opposite the first end. A second accelerometer is configured to measure acceleration of a second end of the test specimen when mounted in the second specimen support and provide a second acceleration output signal. An actuator is mounted to the base and is connected to one of the second specimen support or the second end of the elongated strut. A load cell is mounted to the crosshead and connected to a remaining one of the second specimen support or the second end of the elongated strut that is not connected to the actuator.

A third aspect is a method for testing a damper specimen and an elastomeric specimen with a testing machine, the testing machine having a base, a crosshead, a pair of vertical columns mounted to the base and the crosshead to support the crosshead above the base, an actuator mounted in the base and a load cell connected to the crosshead. The method comprises:
mounting the damper specimen in the testing machine by forming a series connection of a first damper support joined to the actuator, a second damper support joined to the load cell and the damper specimen joined to and between the first damper support and the second damper support;
operating the actuator to test the damper specimen;
removing the damper specimen, the first damper support and the second damper support from the testing machine;
mounting the elastomeric specimen in the testing machine by forming a series connection of an elongated strut, a force transducer an accelerometer assembly comprising a force transducer and a first accelerometer, a first specimen support, the elastomeric test specimen, and a second specimen support; and
operating the actuator and the force transducer to test the elastomeric specimen.

In embodiments of the specimen support assembly, the testing system and the method for testing, the first accelerometer can be disposed between the force transducer and the elongated strut, while in another embodiments, the first accelerometer can be disposed between the force transducer and the first specimen support. An overall length of the elastomeric specimen assembly including the specimen supports, elastomeric test specimen and force and accelerometer assembly, i.e. from the second end of the second specimen support opposite the first end of the second specimen support to the second end of the elongated strut is at least about 0.5 meters in length. In another embodiment, the overall length is at least about 0.7 meters in length, and yet another embodiment, the overall length is at least about 0.9 meters in length. Since the elongated strut primarily is the component that increases the whole assembly to be long enough so as to be used in the damper testing machine, the length of the elongated strut may be at least about 0.1 meters in length. In another embodiment, the elongated strut is at least about 0.25 meters in length, and in yet another embodiment, the elongated strut is at least about 0.4 meters in length.

In embodiments of the testing system and the method, the strut is connected to the end of the force transducer and accelerometer opposite the elastomeric test specimen. The strut in combination with the force transducer accelerometer assembly, the first and second specimen supports and the elastomeric test specimen thus is of sufficient length so as to be operatively connected between the actuator and the load cell. Preferably, a combined length of the elongated strut, the first transducer and accelerometer, the first specimen support, the elastomeric test specimen, and the second specimen support are all connected in series for testing in the testing machine and have a combined length at least as long as the series connected damper specimen supports and the damper test specimen when damper tests are performed in the test specimen. In preferable embodiments, when a vertical position of the crosshead relative to the base is adjustable and has a lowest vertical position closest to the base, this minimum distance between the end of the actuator and the load cell is larger than a length of the force transducer accelerometer assembly, the first specimen support, the elastomeric test specimen and the second specimen support connected in series. Thus, when elastomeric testing is desired, the elongated strut can be connected in series with the force transducer accelerometer assembly. The elongated strut has a length which, when combined with the length of the force transducer accelerometer assembly, the first specimen support, the elastomeric test specimen and the second specimen support connected in series, is equal to or greater than the minimum distance between the end of the actuator and the load cell that can be achieved with the crosshead in its lowest position.

The actuator can be connected to the second end of the second support opposite the first end of the second support and the load cell is connected to the second end of the elongated strut. However, in an alternative embodiment the assembly can be inverted where the second end of the second support is connected to the load cell and the second end of the elongated strut is connected to the actuator.

### BRIEF DESCRIPTION OF THE DRAWINGS

FIG. 1 is a schematic illustration of a damper testing system having an elastomeric specimen support assembly mounted therein and a damper support assembly adjacent elastomeric specimen support assembly.

FIG. 2 is a sectional view of an elastomeric test specimen mounted in the elastomeric specimen support assembly.

FIGS. 3A and 3B are block diagrams for processing signals from accelerometers.

### DETAILED DESCRIPTION OF ILLUSTRATIVE EMBODIMENTS

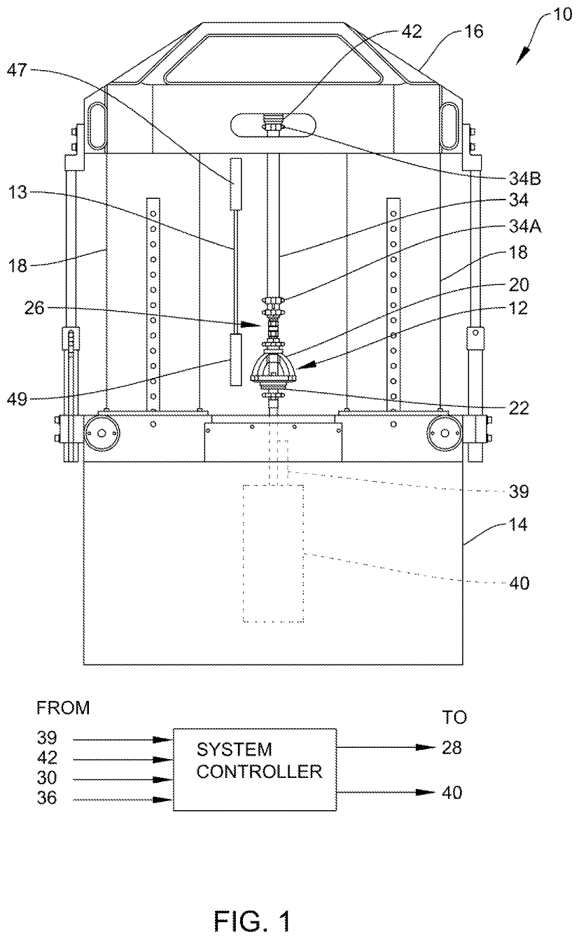

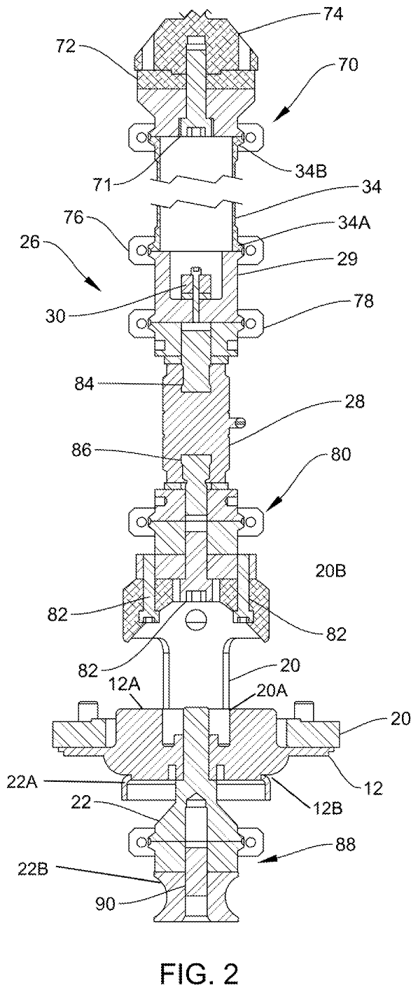

A testing system 10 for applying loads to an elastomeric test specimen 12 is illustrated in FIG. 1 and includes a base 14. A pair of vertical columns 18 is mounted to the base 14 and extends vertically to support across a crosshead 16 above the base 14. Referring also to FIG. 2, a first specimen support 20 has a first end 20A configured to engage a first end 12A of the elastomeric test specimen 12. A second specimen support 22 has a first end 22A configured to engage a second end 12B of the elastomeric test specimen 12.

A force transducer and accelerometer assembly 26 is connected to a second end 20B of the first specimen support 20 opposite the elastomeric test specimen 12. The force transducer and accelerometer assembly 26 includes a force transducer 28 (typically embodied as a piezo electric force transducer) coupled to a support 29 having a first accelerometer 30. The support 29 and the force transducer 28 are coupled in series. The first accelerometer 30 is configured to measure acceleration of the first end 12A of the test specimen 12 when mounted to the first specimen support 20 and provides a first acceleration output signal.

An elongated strut 34 has a first end 34A connected to the force transducer and accelerometer assembly 26 on an end opposite the first specimen support 20. The elongated strut 34 has a second end 34B opposite the first end 34A.

A second accelerometer 36 is configured to measure the acceleration of the second end 12B of the test specimen 12 when mounted to the second specimen support 22. The second accelerometer 36 provides a second acceleration output signal.

An actuator 40 (e.g. hydraulic or electric) is mounted to the base 14 and is connected to one of the specimen support 22 or the second end 30B of the elongated strut 34, depending on the overall orientation of the elastomeric specimen support assembly. A displacement sensor such as but not limited to a linear encoder, LVDT or the like 39 is operatively coupled to the actuator 40 so as to measure and provide a displacement signal indicative of displacement of the end of the actuator 40 and the specimen support connected thereto. A load cell 42 is mounted to the crosshead 16 and is connected to a remaining one of the second specimen support 22 or the second end 30B of the elongated strut 34 that is not connected to the actuator 40.

Although the testing system 10 is specifically designed to test damper specimens such as schematically indicated in FIG. 1 at 13 having opposite ends joined to a first damper support 47 and a second damper support 49, the use of the force transducer 28 and accelerometers 30 and 36 allows suitable forces and displacements to be applied to the elastomeric test specimen 12 at frequencies suitable for elastomeric testing. However, as mentioned in the background section, the testing machine 10 being designed for testing damper specimens 13 is not configured so as to lower the crosshead 16 close enough to the end of the actuator 40 so as to allow the elastomeric test specimen 12 and the force transducer and accelerometer 26 to be connected in series directly to the end of the actuator 40 and the load cell 42.

An aspect of the invention is use of the strut 34 that is connected to the end of the force transducer and accelerometer 26 opposite the elastomeric test specimen. The strut 34 in combination with the force transducer accelerometer assembly 26, the first and second specimen supports 20 and 22 and the elastomeric test specimen 12 thus is of sufficient length so as to be operatively connected between the actuator 40 and the load cell 42. Stated another way, a combined length of the elongated strut 34, the first transducer and accelerometer 26, the first specimen support 20, the elastomeric test specimen 12, and the second specimen support 22 are all connected in series for testing in the testing machine 10 and have a combined length at least as long as the series connected damper specimen supports 47, 49 and the damper test specimen 13 when damper tests are performed in the test specimen 10. Stated yet another way, when a vertical position of the crosshead 16 relative to the base 12 is adjustable and has a lowest vertical position closest to the base 14, this minimum distance between the end 40A of the actuator 40 and the load cell 42 is larger than a length of the force transducer accelerometer assembly 26, the first specimen support 20, the elastomeric test specimen 12 and the second specimen support 22 connected in series. Thus, when elastomeric testing is desired, the elongated strut 34 is connected in series with the force transducer accelerometer assembly 26. The elongated strut 34 has a length which, when combined with the length of the force transducer accelerometer assembly 16, the first specimen support 20, the elastomeric test specimen 12 and the second specimen support 22 connected in series, is equal to or greater than the minimum distance between the end 40A of the actuator 40 and the load cell 42 that can be achieved with the crosshead 16 in its lowest position.

An overall length of the elastomeric specimen assembly including the specimen supports 20,22, elastomeric test specimen 12 and force and accelerometer assembly 26, i.e. from the second end 22B of the second specimen support 22 opposite the first end 22A of the second specimen support 22 to the second end 34B of the elongated strut 34 is at least about 0.5 meters in length. In another embodiment, the overall length is at least about 0.7 meters in length, and yet another embodiment, the overall length is at least about 0.9 meters in length. Since the elongated strut 34 primarily is the component that increases the whole assembly to be long enough so as to be used in the damper testing machine 10, the length of the elongated strut 34 may be at least about 0.1 meters in length. In another embodiment, the elongated strut 34 is at least about 0.25 meters in length, and in yet another embodiment, the elongated strut is at least about 0.4 meters in length.

In the embodiment illustrated in FIG. 1, the actuator 40 is connected to the second end 22B of the second support 22 opposite the first end 22A of the second support 22 and the load cell 42 is connected to the second end 34 of the elongated strut 34. However, in an alternative embodiment the assembly can be inverted where the second end 22B of the second support 22 is connected to the load cell and the second end 34B of the elongated strut 34 is connected to the actuator 40. Likewise, it should also be noted that in the embodiment illustrated the first accelerometer 30 is disposed between the force transducer 28 and the elongated 34; however, in an alternative embodiment the first accelerometer 30 can be disposed between the force transducer 28 and the first specimen support 20.

In FIG. 2 an exemplary embodiment of the elastomeric test specimen holder is illustrated and includes fasteners and adapters that may be advantageous for connection of various components, but such fasteners and adapters should not be considered required. Beginning at end 34B of strut 34, a quick connect adapter and clamp assembly 70 with fastener 71 can be used to join end 34B to a load cell adapter plate 72 and preload adapter 74 that are connected to the load cell 42. Similarly, a quick connect clamp 76 can be used to join end 34A to support 29, while a quick connect clamp 78 can be used to join support 29 to force transducer 28, and a quick connector clamp and adapter assembly 80 and fasteners 82 can be used to join the force transducer 28 to the first specimen support 20. Studs 84 and 86 can be used with the force transducer 28. Finally, a quick connector clamp and adapter assembly 88 and stud 90 are used to join the second specimen support 22 to the actuator 40.

The series connected components coupled to the elastomeric test specimen 12 allows the testing machine 10 to be selectively used to test both damper specimens 13 and elastomeric specimens 12. Generally, a method for testing a damper specimen 13 and an elastomeric specimen 12 with the testing machine 10 comprises selectively choosing when to test damper specimens or alternatively when to test elastomeric specimens. These tests are performed individually and will occur apart from each other in time be it, days, months, years, but nevertheless the same testing machine 10 is used both for damper specimen testing and elastomeric specimen testing thus saving costs both in the initial expenditure just for one testing machine having the base 14, crosshead 16, columns 18 and actuator 40 as well as costs associated with maintenance, and saving laboratory space.

Beginning with damper specimen testing by way of illustration, the damper specimen 13 is mounted in the test machine 10 by forming a series connection of the first damper support 47 joined to the actuator 40 and a second damper support 49 joined to the load cell 42. The damper specimen 13 is joined to and between the first damper support 47 and the second damper support 49. The actuator 40 is controlled by a system controller 41 according to the test to be executed and suitable or and force signals are obtained from the load cell 42 while displacement signals are obtained from the displacement sensor 39 and are correlated to the movements in time of the actuator 40. When testing of the damper specimen 13 is completed, the damper specimen 13, the first damper support 47, and the second damper support 49 are removed from the testing machine 10.

When it is then desired to perform testing upon an elastomeric specimen 12, a series connection of the elongated strut 34, the force transducer accelerometer assembly 26, the first specimen support 20, the elastomeric test specimen support 12 and the second specimen support 22 is constructed in one embodiment away from the test machine 10 although if desired, the components can be installed sequentially in the testing machine 10. As indicated above, the second end of the strut 34B can be joined to one of the actuator 40 or the load cell 42 with the other end of the assembly that being the second end of the second damper support 22 being connected to the remaining one of the end of the actuator 40 or the load cell 42 that the end of the strut 34B is not connected to.

The actuator 40 and the force transducer 28 are controlled by the system controller 41 to perform elastomeric testing. Force and displacement measurements for elastomer dynamic characterization measurements of K* and phase can be broken into two categories. Static measurements and dynamic measurements. The static measurements in the configuration above use the linear encoder 39 and the load cell 42. The dynamic measurements use piezo force transducer 28 and the differential acceleration between the accelerometers 30 and 36. Herein a novel configuration is to utilize existing static measurement transducers which are incorporated into testing machine 10, specifically the load cell 42 and encoder 39. And for dynamic measurements, utilize transducers located closer to the specimen under test (specifically the piezo force transducer 28 and accelerometers 30 and 36) to reduce any dynamic errors introduced in the load path of the strut 34 on either the force measurement or on the displacement measurement, which is derived from acceleration measurements from the accelerometers 30 and 36.

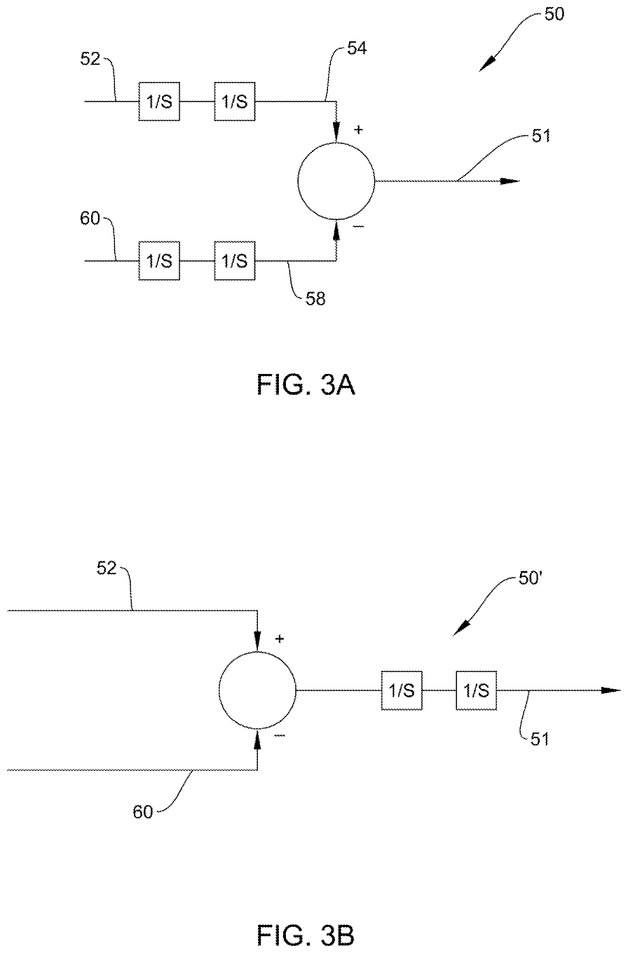

A first displacement compensator or corrector 50 (FIG. 3A), which can be embodied in system controller 30, herein described measures vibration displacement of the fixed side of the test specimen 12, and subtracts this measured deflection from the actuator rod measured displacement of actuator 40, which is indicative of displacement of the other side of the test specimen 12. Referring to FIG. 3A, the relative resultant displacement output signal 51 can be determined by taking a signal 52 indicative of displacement of the side of the test specimen 12, for example as measured via the piston actuator rod (e.g. as ascertained by double integration of the accelerometer 36 to provide signal 54) and subtracting a signal 58 indicative of displacement of the fixed side of the test specimen 12 (e.g. double integration of a signal 60 from the accelerometer 30). A first version of a displacement compensator or corrector is illustrated at 50 in FIG. 3A. However, since the integration process is a linear operation, the equivalent signal can be formulated by first subtracting the signals from the accelerometers 30 and 36 and then performing the double integration on the resulting signal to derive the differential displacement as illustrated in a displacement compensator or corrector 50′ of FIG. 3B. In other words, either technique can be employed.

It should be noted a further configuration is possible. In this further configuration, not shown, the strut 34 is directly attached to the actuator 40. An accelerometer support like support 29 for accelerometer 30 is joined to the end of the strut 34 opposite the actuator 40. The first test specimen support 20, the elastomeric test specimen 12 and the second test specimen support are connected in series to the accelerometer support 29. The force transducer 28 is joined to the end of the second specimen support opposite the test specimen 12 and at an opposite end is joined to the load cell 42. The force transducer 28 applies dynamic force while differential acceleration herein between the accelerometer 30 and acceleration compensation which is permanently attached inside the load cell 42.

Although the present invention has been described with reference to preferred embodiments, workers skilled in the art will recognize that changes may be made in form and detail without departing from the spirit and scope of the invention.

What is claimed is:

1. A testing system for applying loads to an elastomeric test specimen, the testing system comprising:
a base;
a crosshead;
a pair of vertical columns mounted to the base and the crosshead to support the crosshead above the base;
a first specimen support having a first end configured to engage a first end of the elastomeric test specimen;
a second specimen support having a first end configured to engage a second end of the elastomeric test specimen;
a force transducer and accelerometer assembly connected to a second end of the first specimen support opposite the elastomeric test specimen, comprising:
a force transducer; and
a first accelerometer operably coupled in series with the force transducer, the first accelerometer configured to measure acceleration of a first end of the elastomeric test specimen when mounted in the first specimen support and provide a first acceleration output signal;
an elongated strut having a first end connected to the force transducer and accelerometer assembly on an end opposite the first specimen support and having a second end opposite the first end;
a second accelerometer configured to measure acceleration of a second end of the elastomeric test specimen when mounted in the second specimen support and provide a second acceleration output signal;
an actuator mounted to the base connected to one of the second specimen support or the second end of the elongated strut; and
a load cell mounted to the crosshead and connected to a remaining one of the second specimen support or the second end of the elongated strut that is not connected to the actuator.

2. The testing machine of claim 1, wherein a combined length of the elongated strut, the force transducer and accelerometer assembly, the first specimen support, the elastomeric test specimen, and the second specimen support being all connected in series for testing in the testing machine is at least as long as series connected damper specimen supports and a damper test specimen for testing in the testing machine.

3. The testing machine of claim 1, wherein the actuator is connected to a second end of the second specimen support opposite the first end of the second specimen support and the load cell is connected to the second end of the elongated strut.

4. The testing machine of claim 3, wherein the first accelerometer is disposed between the force transducer and the elongated strut.

5. The testing machine of claim 3, wherein the first accelerometer is disposed between the force transducer and the first specimen support.

6. The testing machine of claim 1, wherein the actuator is connected to the second end of the elongated strut and a second end of the second specimen support opposite the first end of the second specimen support is connected to the load cell.

7. The testing machine of claim 1, wherein a vertical position of the crosshead relative to the base is adjustable having a lowest vertical position closest to the base, and wherein a minimum distance between an end of the actuator and the load cell is larger than a length of the force transducer and accelerometer assembly, the first specimen support, the elastomeric test specimen, and the second specimen support connected in series, and wherein a length of the elongated strut and the length of the force transducer and accelerometer assembly, the first specimen support, the elastomeric test specimen and the second specimen support connected in series is equal to or greater than the minimum distance between the end of the actuator and the load cell.

8. The testing machine of claim 7, wherein a distance from a second end of the second specimen support opposite the first end of the second specimen support to the second end of the elongated strut with the elastomeric test specimen for testing in the testing machine is at least about 0.5 meters.

9. The testing machine of claim 7, wherein a distance from a second end of the second specimen support opposite the first end of the second specimen support to the second end of the elongated strut with the elastomeric test specimen for testing in the testing machine is at least about 0.7 meters.

10. The testing machine of claim 7, wherein a length of the elongated strut is at least about 0.1 meters.

11. The testing machine of claim 7, wherein a length of the elongated strut is at least about 0.25 meters.

12. A method for testing a damper specimen and an elastomeric test specimen with a testing machine, the testing machine having a base, a crosshead, a pair of vertical columns mounted to the base and the crosshead to support the crosshead above the base, an actuator mounted in the base and a load cell connected to the crosshead, the method comprising:
mounting the damper specimen in the testing machine by forming a series connection of a first damper support joined to the actuator, a second damper support joined to the load cell and the damper specimen joined to and between the first damper support and the second damper support;
operating the actuator to test the damper specimen;
removing the damper specimen, the first damper support and the second damper support from the testing machine;
mounting the elastomeric test specimen in the testing machine by forming a series connection of an elongated strut, a force transducer an accelerometer assembly comprising a force transducer and a first accelerometer, a first specimen support, the elastomeric test specimen, and a second specimen support; and
operating the actuator and force transducer to test the elastomeric test specimen.

13. The method of claim 12, wherein a vertical position of the crosshead relative to the base is adjustable having a lowest vertical position closest to the base, and wherein a minimum distance between an end of the actuator and the load cell is larger than a length of the force transducer and accelerometer assembly, the first specimen support, the elastomeric test specimen, and the second specimen support connected in series, and wherein a length of the elongated strut and the length of the force transducer and accelerometer assembly, the first specimen support, the elastomeric test specimen and the second specimen support connected in series is equal to or greater than the minimum distance between the end of the actuator and the load cell.

14. The method of claim 13, wherein a first end of the second specimen support is joined to the elastomeric test specimen, and wherein a distance from a second end of the second specimen support opposite a first end of the second specimen support to the second end of the elongated strut with the elastomeric test specimen for testing in the testing machine is at least about 0.5 meters.

15. The method of claim 13, wherein a first end of the second specimen support is joined to the elastomeric test specimen, and wherein a distance from a second end of the second specimen support opposite the first end of the second specimen support to the second end of the elongated strut with the elastomeric test specimen for testing in the testing machine is at least about 0.7 meters.

16. The method of claim 13, wherein a length of the elongated strut is at least about 0.1 meters.

17. The method of claim 13, wherein a length of the elongated strut is at least about 0.25 meters.

18. An assembly for testing an elastomeric test specimen comprises:
a first specimen support having a first end configured to engage a first end of the elastomeric test specimen;
a second specimen support having a first end configured to engage a second end of the elastomeric test specimen;
a force transducer and accelerometer assembly connected to a second end of the first specimen support opposite the elastomeric test specimen, comprising:
a force transducer; and
a first accelerometer operably coupled in series with the force transducer, the first accelerometer configured to measure acceleration of a first end of the elastomeric test specimen when mounted in the first specimen support and provide a first acceleration output signal;
an elongated strut having a first end connected to the force transducer and accelerometer assembly on an end opposite the first specimen support and having a second end opposite the first end;
a second accelerometer configured to measure acceleration of a second end of the elastomeric test specimen when mounted in the second specimen support and provide a second acceleration output signal.

19. The assembly of claim 18, wherein the first accelerometer is disposed between the force transducer and the elongated strut.

20. The assembly of claim 18, wherein the first accelerometer is disposed between the force transducer and the first specimen support.
